(19) United States
(12) Patent Application Publication
(10) Pub. No.: US 2009/0081341 A1
(43) Pub. Date: Mar. 26, 2009

(54) Method and device for printing color images on chocolate products

(76) Inventor: Isar Mandelboum, Netanya (IL)

Correspondence Address: Pearl Cohen Zedek Latzer, LLP, 1500 Broadway, 12th Floor, New York, NY, 10036, US

(21) Appl. No.: 11/902,802

(22) Filed: Sep. 25, 2007

(51) Int. Cl. A23G 1/22; A23P 1/08

(52) U.S. Cl. 426/249; 99/450.1

(57) ABSTRACT

A method and device for the production of a chocolate product having a colored image imprinted thereon. The method comprises providing a substrate with a non-stick surface, depositing a food-color-receiving emulsion on the substrate, printing on the emulsion with ink-jet food grade colors, depositing melted chocolate on the printed emulsion in a mold, and allowing said molded chocolate to cool. The printed image transfers to said chocolate with said emulsion and the outcome is a chocolate product with the colored image imprinted thereon.

### FIELD OF THE INVENTION

The present invention relates to a method and device for the preparation of a chocolate product having a colored picture imprinted thereon. More specifically the present invention is directed to process and device enabling direct printing on real chocolate at ambient temperatures, in photo-quality while using high-rate industrial procedures.

### BACKGROUND OF THE INVENTION

The decorating of cakes with images wherein the images are imprinted on the icing of the cake is well-known in the art, however heretofore there has neither been taught nor suggested an efficient and successful method for providing hard chocolates with colored images directly imprinted thereon.

U.S. Pat. No. 6,623,553 (Russel et al.) disclosed an edible ink with a viscosity of about 2000 to about 16000 cp at 25.degree. C. It was suggested in that patent to use a blanket cylinder for transferring an ink layer onto a surface of the blanket cylinder and from there onto an edible substrate (sugar fondant, wafer, rice paper, starch sheets, sugar sheets and icing).

In WO 03/045704, there was disclosed a decorating kit including a transfer sheet having printed thereon a substantially non-tacky layer of an edible ink. The ink may be used in a transfer printing process for forming an image layer on a surface of an edible article. The transfer process includes providing a transfer sheet with a substantially non-tacky layer of an edible ink thereon; contacting the layer of edible ink with the surface of the edible article; and removing the transfer sheet such that the ink releases therefrom and forms an image layer on the surface of the edible article.

It is an object of the present invention to provide a method for printing colored image of high quality onto a chocolate product.

It is another object of the present invention to provide a method for printing colored image of high quality onto a chocolate product that is suitable for printing on white chocolate.

Yet another object of the present invention is to provide a method for printing colored image of high quality onto a chocolate product, suitable for brown chocolate too.

### SUMMARY OF THE INVENTION

Thus according to the present invention there is now provided a method for the production of a chocolate product having a colored picture imprinted thereon comprising:

a) providing a substrate with a non-stick surface

b) depositing a food-color-receiving emulsion on said substrate

c) printing on said emulsion with ink-jet food grade colors;

d) depositing melted chocolate# on said printed emulsion in a mold and

e) allowing said molded chocolate to cool;

whereby said printed image transfers to said chocolate with said emulsion and the outcome is a chocolate, covered with any printed image in photo quality.

In a preferred embodiment of the present invention there is provided a method for the production of a chocolate product having a colored picture imprinted thereon comprising:

a) providing a substrate with a non-stick surface;

b) providing an emulsion comprising a regular or modified starch, sugar, an emulsifier, water and hydrogenated oil;

c) depositing said emulsion on said substrate;

d) evaporating said emulsion to form a food-color-receiving surface;

e) printing on said surface with ink-jet food grade colors;

f) depositing melted chocolate on said printed emulsion in a mold; and

g) allowing said molded chocolate to cool;

whereby said printed image transfers to said chocolate with said emulsion.

In preferred embodiments of the present invention said starch is a crisp film starch.

Preferably said substrate is selected from the group consisting of PVC, PET, and other food-grade non-stick materials, which are stiff enough to hold an ink-jet procedure.

In especially preferred embodiment of the present invention said emulsion is prepared by first combining sugar, starch and water at room temperature, heating the mixture to a temperature of between about 60-90° C., homogenizing said mixture, and adding at least one emulsifier to form a first mixture, melting the hydrogenated oil and adding a further emulsifier thereto to form a second mixture and then combining said first mixture and second mixture in a homogenizer to form said emulsion.

In preferred embodiments of the present invention said emulsion is prepared using granulated sugar, tapuka starch, crisp film starch, hydrogenated palm oil 51-53, mono di glycerin, polysorbate 60 and water.

As will be realized the granulated sugar could be replaced by regular sugar, maltodextrin, cane sugar and other sugars, the tapuka starch could be replaced by other modified starch, the crisp film starch could be replaced by other film starch, the mono-di-glycerin emulsifier could be replaced by other emulsifiers such as colco, lecithin, soy lecithin, polysorbate, etc. and the polysorbate 60 emulsifier could be replaced by other emulsifiers although the above composition is preferred.

### DETAILED DESCRIPTION OF PREFERRED EMBODIMENTS

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### Example 1

An emulsion for use in the process of the present invention was prepared composed of the following ingredients:

| Raw material | Grams | % Of mass |
|---|---|---|
| Granulated sugar | 20.00 | 1.60% |
| Tapuka starch | 12.00 | 0.96% |
| Crisp film starch | 12.00 | 0.96% |
| Hydrogenated palm oil 51-53 | 185.00 | 14.76% |
| Mono di glycerin | 12.00 | 0.96% |
| Polysorbate 60 | 12.00 | 0.96% |
| Water | 1,000.00 | 79.81% |
| | 1,253.00 | 100.00% |

### Example 2

1) Using the ingredients of example 1 an emulsion for deposit was prepared as follows:

a) The sugar, tapuka and crisp film are stirred into room temperature water.

b) The mixture is heated to 80 C

c) The heated mixture is transferred to hi speed homogenizer

d) The p60 is added into the mixture.

e) The oil is melted up to complete liquid

f) The mono-di-glycerin is added into the melted oil

g) Farther heating of about 5 minutes (or as necessary) for the mono-di-glycerin to get the oil temperature.

When said Tapuka starch, other kinds of starches could be used (as CH 20 etc.) Other emulsifiers could be used instead of the P60 and the mono di glycerin (Such as: Lecithin, Etc.)

h) The mixture of the melted oil and the mono-di-glycerin is added as slow as possible to the first mixture while the homogenizer is running

i) Extra homogenizing up to complete emulsion.

2) The emulsion prepared in step 1) is then used in the process of the present invention as follows:

a) The emulsion is implicated on the substrate either by spraying or by mesh printing.

b) The emulsion is evaporated to form a color-receiving surface.

c) An industrial ink-jet printer is used with food-grade ink-jet colors to print an image on said color-receiving surface.

d) Melted chocolate is deposited on said printed surface.

e) The molded chocolate is cooled

f) The molded chocolate with said image is removed from said mold.

### Example 3

Food colors for use in the present method were prepared from the following:

Basic mixture:

| | |
|---|---|
| Water | 1,000 cc |
| Alcohol | 100 cc |
| Glycerin | 30 cc. |

For cyan color there was mixed into the basic mixture:

| | | |
|---|---|---|
| E 133 brilliant blue | 20.8 | grams |
| E 132 indigo carmine | 2.5 | grams |
| For magenta color there was mixed into the basic | | |
| mixture: | | |
| E 124 ponceau | 22 | grams |
| E122 carmoisine | 7 | grams |
| For yellow color there was mixed into the basic mixture: | | |
| E 102 tatrazine | 63 | grams |
| E 141 copper chlorophyll | 1 | gram |
| For black color there was mixed into the basic mixture: | | |
| E 122 carmoisine | 20 | grams |
| E 133 brilliant blue | 5 | grams |
| E 102 tatrazine | 2.5 | grams |

It is also possible to use fats from cocoa butter in the preparation of the emulsion.

The colors indicated hereinabove are to demonstrate that water based colors could be used on said emulsion.

The emulsion is printed (for example, in mesh printing technique, although this is not the only possible printing method) onto the substrate and the colored image is deposited onto the emulsion. Chocolate in melted form is deposited onto the substrate and when the substrate is removed the colored image remains on the surface of the chocolate that faced the substrate. This is suitable for printing onto white chocolate, which itself neutral white color that serves as background for the color image imprinted thereon.

If it is desired to print color images on brown or dark chocolate it is suggested to add titanium dioxide (TiO₂) to the emulsion to obtain opacity in the form of white surface beneath the colored image, serving as background.

In yet another preferred embodiment of the present invention

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for producing a chocolate product having a colored image imprinted thereon comprising:
providing a substrate with a non-stick surface;
depositing a food-color-receiving emulsion on the non-stick surface of said substrate;
printing the colored image on said emulsion using ink-jet food grade colors;
depositing melted chocolate on the printed emulsion in a mold; and
allowing the melted chocolate in the mold to cool;
whereby when the chocolate product is removed from the mold the printed colored image transfers to said chocolate product with said emulsion.

2. A method according to claim 1 wherein the substrate is made from one or more materials selected from a group of materials consisting of PVC, PET.

3. A method according to claim 1 wherein the emulsion is prepared by first combining sugar, starch and water at room temperature, heating the mixture to a temperature of between about 60-90° C., homogenizing said mixture, and adding at least one emulsifier to form a first mixture, melting hydrogenated oil and adding a further emulsifier thereto to form a second mixture and then combining said first mixture and second mixture in a homogenizer to form said emulsion.

4. A method according to claim 1, wherein the emulsion comprises titanium dioxide.

5. A method according to claim 1, wherein the emulsion comprises fats selected from a group of fats consisting: palm oil, coca butter fats.

6. A method for producing a chocolate product having a colored image imprinted thereon comprising:
providing a substrate with a non-stick surface;
providing an emulsion comprising a regular or modified starch, sugar, an emulsifier, water and hydrogenated oil;
depositing said emulsion on the non-stick surface of said substrate;
evaporating said emulsion to form a food-color-receiving surface;
printing on said surface with ink-jet food grade colors;
depositing melted chocolate on said printed emulsion in a mold; and
allowing said molded chocolate to cool, whereby when the chocolate product is removed from the mold the printed colored image transfers to said chocolate product with said emulsion.

7. A method according to claim 6 wherein said starch is a crisp film starch.

8. A substrate device for use in producing a chocolate product having a colored image imprinted thereon, the device comprising a substrate having a non-stick surface with a food-color-receiving emulsion on the non-stick surface of the substrate.

9. A substrate device as claimed in claim 8, wherein the emulsion comprises titanium dioxide.

10. A substrate device as claimed in claim 8, wherein the emulsion comprises regular or modified starch, sugar, an emulsifier, water and hydrogenated oil.
